(19) United States
(12) Patent Application Publication
(10) Pub. No.: US 2015/0132504 A1
(43) Pub. Date: May 14, 2015

(54) Method for Fabricating Carbon Molecular Sieve Membrane

(71) Applicant: CHUNG-YUAN CHRISTIAN UNIVERSITY, Tao-Yuan (TW)

(72) Inventors: Jung-Tsai Chen, Taoyuan County (TW); Chien-Chieh Hu, Taoyuan County (TW); Kueir-Rarn Lee, Taoyuan County (TW); Juin-Yih Lai, Taoyuan County (TW)

(73) Assignee: CHUNG-YUAN CHRISTIAN UNIVERSITY, Tao-Yuan (TW)

(21) Appl. No.: 14/078,858

(22) Filed: Nov. 13, 2013

(51) Int. Cl. B01D 53/22; B01D 71/02

(52) U.S. Cl. CPC B01D 53/228; B01D 71/021; B01D 2053/221
USPC 427/569; 427/255.6

(57) ABSTRACT

This invention is about a method for fabricating carbon molecular sieve membrane. The above method comprises a step of deposition, and a step of carbonization to obtain a high performance and high selectivity carbon molecular sieve membrane. According to this invention, an ultra-thin and defects free carbon molecular sieve membrane can be obtained. More preferably, the method for fabricating carbon molecular sieve membrane of this invention is easy operating, economic, and environmental friendly.

### BACKGROUND OF THE INVENTION

1. Field of the Invention

The present invention is generally related to a carbon molecular sieve membrane, and more particularly to a method for fabricating carbon molecular sieve membrane.

2. Description of the Prior Art

A carbon molecular sieve membrane is not only with molecular sieve character, but also can provide better gas separation performance than general polymer films. To one skilled in that art, it is known that the manufacturing cost of a carbon molecular sieve membrane is too high, and the produced carbon molecular sieve membrane is usually with defects. Therefore, it is a hard choice to one skilled in that art to entering the study of carbon molecular sieve membrane.

In order to obtain high performance carbon molecular sieve membrane, the resistance in the selective layer should be decreased. A carbon molecular sieve membrane is brittle, so that most researchers try to produce carbon molecular sieve “composite” membrane to avoid the mentioned brittleness problem. The mentioned composite membrane is usually obtained by coating polymer onto a heat-resistant substrate with high mechanical property, processing cross-linking or thermal treatment, and carbonizing.

FIG. 1 shows a method for producing carbon molecular sieve membrane in the prior art. Referred to FIG. 1, polymer material is coated onto the surface of a substrate to form a polymer layer on the substrate, as shown in the step 120. The mentioned polymer material can be coated onto the substrate by spin-coating process. Subsequently, for increasing the degree of cross-linking in the mentioned polymer layer and the connection between the polymer layer and the surface of the substrate, the substrate with polymer is performed a thermal curing process, as shown in the step 140. And then, as shown in the step 160, a carbonizing process is performed, and the carbon molecular sieve membrane is obtained.

If the carbon molecular sieve membrane obtained from performing one time of the manufacturing in FIG. 1 is not defects free, two or more times of the manufacturing in FIG. 1 will be performed to the obtained carbon molecular sieve membrane. Besides, a carbon molecular sieve membrane with defects or with poor separation performance also can be performed the manufacturing as FIG. 1 to form one or more new carbon molecular sieve membrane(s) onto the original carbon molecular sieve membrane to overcome the defects of the original carbon molecular sieve membrane. Repeating the coating and the carbonizing process in FIG. 1 can gradually decrease the defects of a carbon molecular sieve membrane, but the mentioned repeating process will increase the thickness of the final product and the resistance of the carbon molecular sieve membrane. That is, repeating the manufacturing as FIG. 1 can gradually the defects of the carbon molecular sieve membrane, and will decrease the performance of the carbon molecular sieve membrane at the same time. Moreover, from the viewpoint of manufacturing cost, each additional coating and carbonizing process will bring lots of depletion of time and energy, so that the manufacturing cost will be increased and it is very environmental un-friendly.

In view of the above matters, developing a novel method for fabricating carbon molecular sieve membrane, wherein the carbon molecular sieve membrane is with high separation performance and defects free, having the advantage of simply operating and low cost is still an important task for the industry.

### SUMMARY OF THE INVENTION

In light of the above background, in order to fulfill the requirements of the industry, the present invention provides a novel method for fabricating carbon molecular sieve membrane having the advantage of simply operating and lower cost than the cost of the manufacturing in the prior art. And, the carbon molecular sieve membrane obtained from the method of this invention can provide great gas separation performance and permeability. So that the mentioned method of this invention can efficiently improve the industrial competitive ability.

One object of the present invention is to provide a method for fabricating carbon molecular sieve membrane to produce carbon molecular sieve membrane by forming pristine membrane with polymerization deposition, and modulating the fine structure of the pristine membrane through carbonizing process to producing carbon molecular sieve membrane.

Another object of the present invention is to provide a method for fabricating carbon molecular sieve membrane to produce carbon molecular sieve membrane without surface defects by performing one time of polymerization deposition-carbonization manufacturing, so that the thickness of the produced carbon molecular sieve membrane can be reduced and the permeability of the produced carbon molecular sieve membrane can be efficiently improved.

Still another object of the present invention is to provide a method for fabricating carbon molecular sieve membrane to produce carbon molecular sieve membrane without defects by performing one time of polymerization deposition-carbonization manufacturing, so that the mentioned method is more saving time and energy, and more simply operating than the manufacturing in the prior art.

Accordingly, the present invention discloses a method for fabricating carbon molecular sieve membrane. The mentioned method for fabricating carbon molecular sieve membrane comprises performing plasma enhanced chemical vapor deposition (PECVD) process to uniformly coat reacting monomer onto the surface of a substrate, and performing carbonizing process. Through the mentioned PECVD process, a pristine membrane is formed on the substrate. The mentioned carbonizing process can transfer the substrate with the pristine membrane into carbon molecular sieve membrane, and can further modulate the fine structure in the membrane for improving the separation performance of the carbon molecular sieve membrane. According to this invention, carbon molecular sieve membrane, with high separation performance and high permeability and without defects, can be obtained by one time deposition-carbonization process. Comparing with the multiple polymer coating-carbonizing process in the prior art, the method of this invention can reduce the manufacturing time, save the energy and cost of the manufacturing, and produce less environmental waste. Preferably, the method of this invention is more simply operating than the manufacturing process in the prior art. More preferably, the carbon molecular sieve membrane fabricated by this invention can provide really good gas permeability and gas selectivity. Therefore, the method of this invention can help to increase industrial competitive ability.

### BRIEF DESCRIPTION OF THE DRAWINGS

The present disclosure can be described by the embodiments given below. It is understood, however, that the embodiments below are not necessarily limitations to the present disclosure, but are used to a typical implementation of the invention.

FIG. 1 shows a method for producing carbon molecular sieve membrane in the prior art;

FIG. 2 shows a method for fabricating carbon molecular sieve membrane according to one embodiment of this invention;

FIGS. 3A to 3D shows the SEM (scanning electron microscope) images of PFA (polyfurfuryl alcohol) composite film made by spin-coating-carbonizing process in the prior art, wherein FIGS. 3A and 3B respectively illustrate the surface and the cross-section of the pristine membrane after PFA spin-coating process, wherein FIGS. 3C and 3D respectively illustrate the surface and the cross-section of the PFA composite film after carbonizing process;

FIG. 4 shows the comparison of ATR-FTIR spectrums of the carbon molecular sieve membrane made of PFA and the carbon molecular sieve membrane made of FA (furfuryl alcohol) by the method of this invention;

FIGS. 5A to 5H shows the SEM images of carbon molecular sieve membrane consisted of FA monomer produced according this invention and under different carbonizing temperature, wherein FIGS. 5A and 5B respectively illustrate the surface and the cross-section of the pristine membrane, wherein FIGS. 5C and 5D respectively illustrate the surface and the cross-section of the carbon molecular sieve membrane (cp300) through carbonizing temperature at 300° C., wherein FIGS. 5E and 5F respectively illustrate the surface and the cross-section of the carbon molecular sieve membrane (cp500) through carbonizing temperature at 500° C., wherein FIGS. 5G and 5H respectively illustrate the surface and the cross-section of the carbon molecular sieve membrane (cp700) through carbonizing temperature at 700° C.;

FIGS. 6A and 6B respectively show the Doppler broadening energy spectroscopy (DBES, S parameter VS Positron Annihilation Energy) of carbon molecular sieve membranes consisted of FA monomer and produced under different carbonizing temperature according to this invention;

FIG. 7 shows the Doppler-broadened energy spectrums (DBES, R parameter VS Positron Annihilation Energy) of carbon molecular sieve membranes consisted of FA monomer and produced under different carbonizing temperature according to this invention;

FIG. 8 shows the ATR-FTIR spectrums of carbon molecular sieve membrane, pristine membrane, and ceramic substrate consisted of FA monomer and produced under different carbonizing temperature according to this invention;

FIG. 9 shows the Element Analysis spectrums of carbon molecular sieve membrane, and pristine membrane consisted of FA monomer and produced under different carbonizing temperature according to this invention;

FIGS. 10A and 10B respectively shows the X-ray photoelectron spectrums of carbon molecular sieve membranes, and pristine membrane consisted of FA monomer and produced under different carbonizing temperature according to this invention, wherein FIG. 10A illustrates the Cls spectroscopy, wherein FIG. 10B illustrates the Ols spectroscopy;

FIG. 11 shows the Raman spectrums of carbon molecular sieve membrane, and pristine membrane consisted of FA monomer produced under different carbonizing temperature according to this invention; and

FIGS. 12A and 12B shows the gas separation performance of carbon molecular sieve membrane, and pristine membrane consisted of FA monomer and produced under different carbonizing temperature according to this invention, wherein FIG. 12A illustrates that the gas separating target is O₂/N₂, wherein FIG. 12B illustrates that the gas separating target is CO₂/N₂.

### DESCRIPTION OF THE PREFERRED EMBODIMENTS

What probed into the invention is a method for fabricating carbon molecular sieve membrane. Detailed descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater details in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

One preferred embodiment according to this specification discloses a method for fabricating carbon molecular sieve membrane. The mentioned method comprises performing a chemical vapor deposition (CVD) process to coat reacting monomer onto the surface of a substrate to form a pristine membrane, and performing a carbonizing process. In one preferred example of this embodiment, through the test result of gas separation, one deposition-carbonization process can provide the carbon molecular sieve membrane with very thin selective layer and without structure defects.

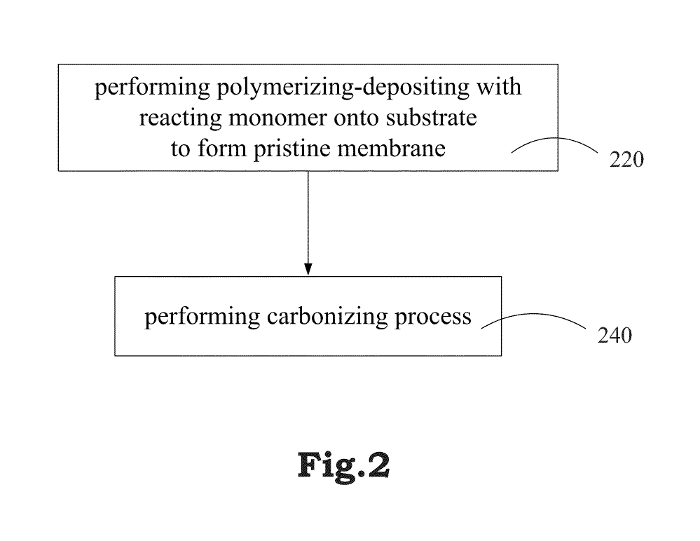

FIG. 2 shows a method for fabricating carbon molecular sieve membrane of this embodiment. Firstly, a chemical vapor deposition (CVD) process is performed to coat reacting monomer uniformly onto the surface of a substrate to form a pristine membrane, as shown in the step 220. The substrate can be selected from one of the group consisted of the following: ceramics, carbon. In one preferred example of this embodiment, the mentioned substrate is selected from one of the following: ceramic, carbon. In one preferred example of this embodiment, the mentioned substrate can be a ceramic substrate with average surface hole size about 10 nm. The mentioned reacting monomer can be selected from one of the group consisted of the following: furfuryl alcohol (FA), tetramethylsilane (TMS), hexamethyl disilazane (HMDSN), hexamethyl disiloxane (HMDSO), 1,1,3,3-tetramethyldisiloxane (TMDSO) cyclohexane and TEOS, benzene (C₆H₆) and octafluorocyclobutane (OFCB, C₄F₈), ethylcyclohexane and Tetraethoxysilane, tetramethyltin (TMT), hexafluoropropylene oxide (C₃F₆O), L-tyrosin, acrylonitrile, 2-hydroxyethyl methacrylate and titanium tetraisopropoxide, 3,3,3-trifluoropropyl trimethoxysilane, pentafluorophenyl triethoxysilane and heptadecafluoro-1,1,2-tetrahydrodecyl triethoxysilane, 1,3,5-trivinyl-1,1,3,5,5-pentamethyltrisiloxane (TVTSO).

In one preferred example of this embodiment, the reacting monomer can be coated onto the surface of the substrate through Plasma-enhanced chemical vapor deposition (PECVD) process. In one preferred example, the power of the PECVD process is about 10-100 W. According to this embodiment, through the PECVD process, the reacting monomer can form a polymer pristine membrane on the surface of the substrate. Preferably, there exists excellent cross-linking property inside the pristine membrane, and there is great connection between the pristine membrane and the surface of the substrate.

Subsequently, the substrate with the pristine membrane is passed through a carbonizing process, as shown in the step 240, to produce the carbon molecular sieve membrane of this embodiment. In one preferred example of this embodiment, the temperature range of the mentioned carbonizing process is about 450-900° C. Preferably, in one preferred example, the temperature range of the mentioned carbonizing process is about 500-700° C. In one preferred example of this embodiment, the thickness of the mentioned carbon molecular sieve membrane is about 0.1-1.0 μm. In another preferred example of this embodiment, the thickness of the mentioned carbon molecular sieve membrane is about 0.2-0.6 μm. In still another preferred example of this embodiment, the thickness of the mentioned carbon molecular sieve membrane is about 200 nm. In one preferred example of this embodiment, the CO₂/N₂ gas selectivity of the mentioned carbon molecular sieve membrane is about 2.0-20. In one preferred example of this embodiment, the O₂/N₂ gas selectivity of the mentioned carbon molecular sieve membrane is about 5.0-15.

According to this embodiment, after the carbonizing process, the obtained carbon molecular sieve membrane is defect free, and can provide excellent gas permeability and selectivity, so that the mentioned carbon molecular sieve membrane can present excellent gas separating performance. Preferably, the mentioned carbon molecular sieve membrane does not have to perform multiple repeating times of coating-carbonizing process to erase the defects in the carbon molecular sieve membrane. In other words, comparing with the manufacturing process of carbon molecular sieve membrane in the prior art, the method for fabricating carbon molecular sieve membrane of this embodiment can save time and energy of the manufacturing process, and efficiently decrease the thickness of the carbon molecular sieve membrane.

The preferred examples of the structure and fabricating method for fabricating carbon molecular sieve membrane according to the invention are described in the following. However, the scope of the invention should be based on the claims, but is not restricted by the following examples.

Equipments:

1. Three-zone horizontal vacuum furnace: Thermal Fisher Scientific

2. plasma-enhanced chemical vapor deposition: assembled by Inventors

3. scanning electron microscope (SEM): Hitachi Co., Model S-3000N and FE-SEM Model S-4800

4. ATR-FTIR: Perkine Elmer, Miracle-Dou

5. X-ray Photoelectron Spectroscope (XPS): Thermo Fisher Scientific K-Alpha

6. Raman spectrum Analyzer: Coherent Innova 70

7. Gas Permeability Analyzer: Yanoco GTR-10

8. Gas Chromatography: Shimadzu Co., GC-14A

9. positron annihilation lifetime spectroscopy (PALS): assembled by Inventors

10. variable mono-energy slow positron beam (VMSPB): assembled by Inventors

Method for Fabricating Carbon Molecular Sieve Membrane:

A Example of the method for fabricating carbon molecular sieve membrane according to the invention are described in the following. However, the scope of the invention should be based on the claims, but is not restricted by the following examples.

After cleaning the surface of a ceramic substrate with air gun, the ceramic substrate is put into the center of a plasma reactor. When the plasma reactor is vacuumed to 0.045 torr with rotary pump, a cylinder with furfuryl alcohol (FA) monomer is opened, wherein the cylinder is put at 50° C. for at least one day. The pressure of entire system is controlled at about 0.2 torr. After opening the cylinder for 30 minutes, the ceramic substrate is performed a deposition process for 1 hour under the plasma power as 10 w to form a plasma deposition pristine membrane on the ceramic substrate.

The ceramic substrate with pristine membrane is subsequently passed through a carbonizing process in the three-zone horizontal vacuum furnace to produce the carbon molecular sieve membrane. The mentioned three-zone horizontal vacuum furnace has three heating zone. Those two side heating zones are used to keep the temperature of the central heating zone in consistency. The mentioned ceramic substrate with pristine membrane is put on a quartz boat, and the quartz boat is pushed to the central heating area by a quartz rod. After vacuumed to 10⁻² torr for at least 8 hours, the temperature raising step of the carbonizing process is begun. When the carbonizing process is finished, the temperature is lowered by fixed speed cooling or natural cooling, and then the carbon molecular sieve membrane is obtained.

### Example 1

### Gas Separation Comparison of the Carbon Molecular Sieve Membranes Form the Pristine Membrane Produced by Spin-Coating and Plasma-Depositing Process

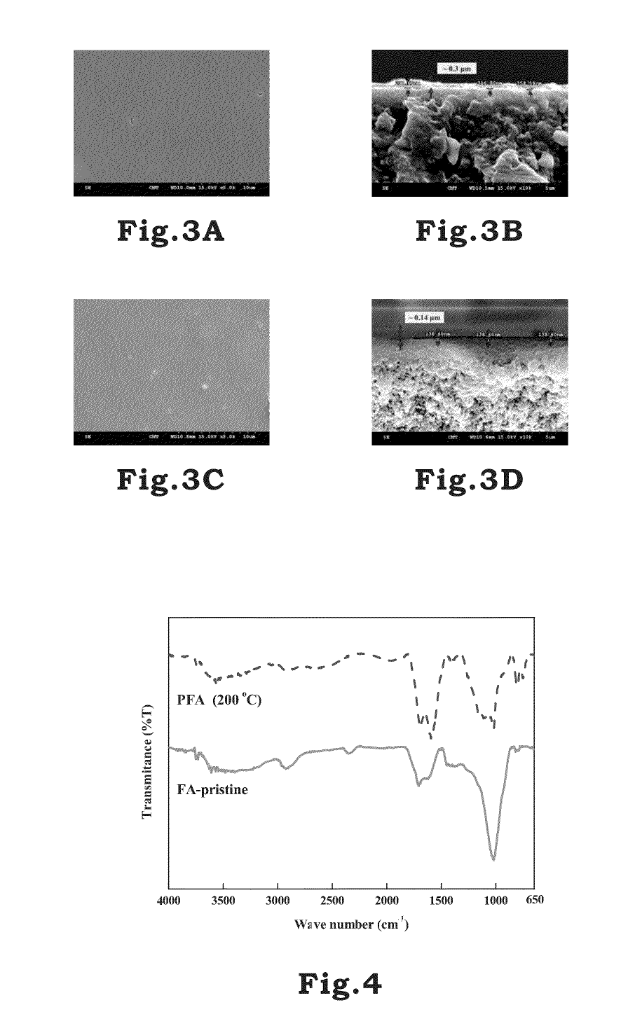

Polyfurfuryl alcohol (PFA) is directly coated onto a substrate by one time spin-coating to obtain the pristine membrane as the control group. We found that it is not easy to obtain a pristine membrane without defects through spin-coating process. FIG. 3A to 3D illustrates the images of scanning electron microscope (SEM) of PFA pristine membrane formed by spin-coating process. FIGS. 3A and 3B respectively show that the images of the surface and the cross-section of the PFA pristine membrane. FIGS. 3C and 3D respectively illustrate the surface and the cross-section of the PFA pristine membrane after carbonizing process. As shown in FIG. 3A, it is obvious that there are many defects at the surface of the PFA pristine membrane. After the carbonizing process, as shown in FIG. 3C, there are still many defects at the surface of the PFA membrane. Additionally, referred to FIGS. 3B and 3D, one time spin-coating process can provide very thin selective layer, about 0.3 μm. However, during the following drying process, the PFA polymer thin liquid layer from spin-coating process could be shrunk non-uniformly cause of the roughness of the surface of the substrate, so that many defects will be form at the surface of the PFA membrane.

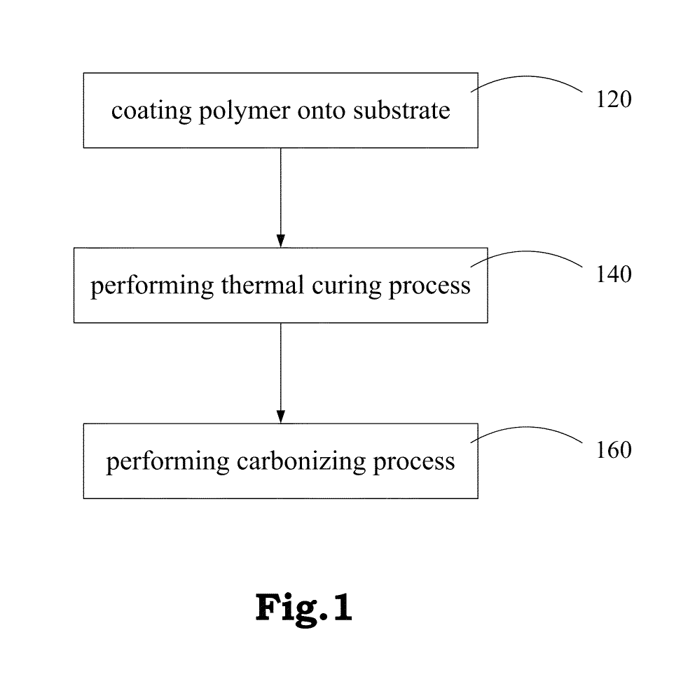

Table 1 shows the gas separation comparison between the membrane from one time spin-coating/carbonizing process, as shown in FIG. 1, and the carbon molecular sieve membrane from one time plasma deposition/carbonization of this invention. The thickness of the mentioned two membranes in Table 1 is the same. Referred to Table 1, it can be found that the carbon molecular sieve membrane from one time spin-coating process does not provide gas separation because of there are many defects in the carbon molecular sieve membrane. As discussed in prior literatures, the mentioned carbon molecular sieve membrane can be proceeded with a second time spin-coating/carbonizing process, for forming 2 layers on the substrate, and the newly obtained carbon molecular sieve membrane can provide carbon dioxide permeability as 888.2 GPU and carbon dioxide/nitrogen (CO₂/N₂) selectivity as 8.9. Because an additional coating and carbonizing procedures, the manufacturing cost of the carbon molecular sieve membrane will be increased. In the prior art, the carbon molecular sieve membrane is produced from spin-coating/carbonizing process, and the carbonizing temperature is about 500° C. And it is about 60 hours for operating two times of the mentioned spin-coating/carbonizing process in the prior art. According to this invention, the carbon molecular sieve membrane without defects can be produced from one time plasma depositing/carbonizing process, and it only spends 20 hours for accomplishing the mentioned one time plasma depositing/carbonizing process. Therefore, the method for fabricating carbon molecular sieve membrane of this invention can efficiently lower the manufacturing cost, and can provide carbon molecular sieve membrane with higher performance.

TABLE 1

| | Permeance (GPU) | | Selectivity | |
|---|---|---|---|---|
| Membrane | CO₂ | O₂ | CO₂/N₂ | O₂/N₂ |
| cPFA500 (1 layer) | over-flow | over-flow | — | — |
| cPFA500 (2 layers) | 888.2 | 229.3 | 8.90 | 2.30 |
| FA-cp500 | 772.1 | 150.6 | 14.32 | 2.79 |
| PFA (1 layer) | 0.758 | 0.749 | 1.16 | 1.14 |
| PFA (2 layers) | 0.101 | 0.084 | 1.80 | 1.49 |
| FA-pristine | 2.998 | 2.585 | 1.13 | 0.97 |

Referred to Table 1, CPFA500 (1 layer) is the membrane obtained from one time spin-coating/carbonizing process in the prior art with PFA. CPFA (2 layers) is the membrane CPFA500 (1 layer) passed through another time spin-coating/carbonizing process in the prior art with PFA. FA-cp500 is the carbon molecular sieve membrane obtained from one time of plasma depositing/carbonizing process of this invention with FA as monomer, carbonizing temperature about 500° C. PFA (1 layer) is the carbon molecular sieve membrane obtained from one time spin-coating/carbonizing process with PFA as monomer. PFA (2 layers) is the carbon molecular sieve membrane obtained from two times of spin-coating/carbonizing process with PFA as monomer. FA-pristine is the pristine membrane obtained from one time plasma depositing procedure with FA as monomer. As shown in Table 1, the PFA membrane without carbonizing process is almost with no gas selectivity. And, the gas selectivity of the FAcp500 membrane obtained from the method of this invention is as good as the gas selectivity of the membrane passed through two times of spin-coating/carbonizing process.

FIG. 4 shows those ATR-FTIR spectrums of the carbon molecular sieve membrane consisted of PFA obtained from spin-coating/carbonizing process and the carbon molecular sieve membrane consisted of FA (furfuryl alcohol) obtained from depositing/carbonizing process of this invention. Referred to FIG. 4, the chemical structure of the pristine composite membrane, obtained from coating PFA onto the ceramic substrate by spin-coating process and then passed through 200° C. cross-linking for 12 hours, is similar to the pristine membrane obtained from plasma depositing process. As shown in FIG. 4, it is easily to find those characteristic absorption peaks in the FTIR spectrums of PFA (200° C.), such as the characteristic absorption peak of —CH₂— at 2925 cm⁻¹, the characteristic absorption peak of ═C—O—C═ of furfan ring at 1025 and 1080 cm⁻¹, the characteristic absorption peak of —C═C— of furfan ring at 1570 and 1510 cm⁻¹, and the characteristic absorption peak of —OH at 3650 cm⁻¹. That is, comparing with the PFA compositing membrane, there is only partial cross-linking structure formed in the pristine membrane obtained from plasma depositing process with FA.

### Example 2

### Carbonizing Temperature Effects to FA Pristine Membrane from Plasma Deposition and to Carbon Molecular Sieve Composite Membrane

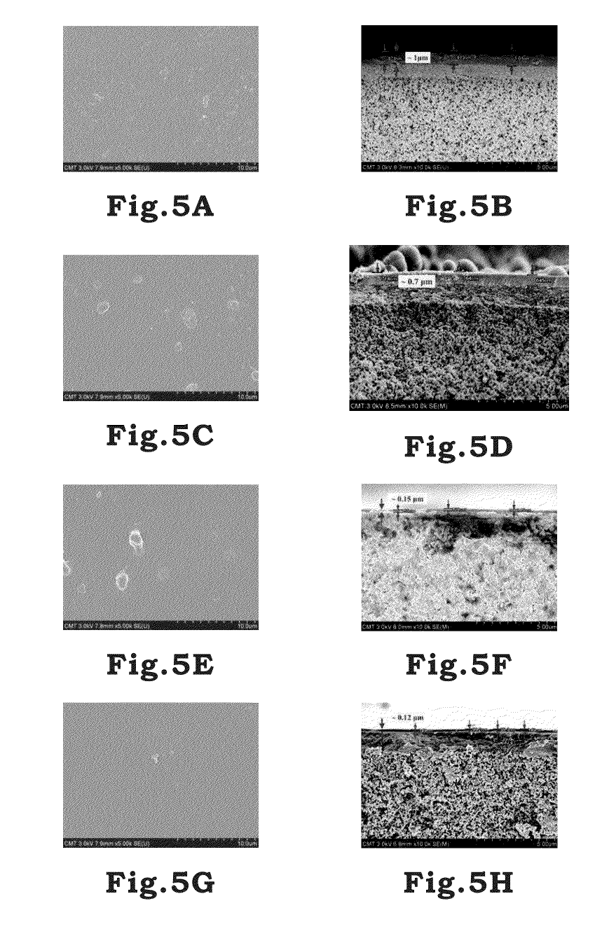

After performing plasma depositing process with FA monomer, a continue plasma depositing layer with thickness about 1 μm is formed and entirely covered on the surface of a porous ceramic substrate, as shown in FIGS. 5A and 5B. It can be found that there is no defect at the surface. Because the size of the monomer is a little bit large, and the plasma power is 10 W, there is some particle at the surface of the pristine membrane. During the plasma depositing process, if the plasma power is not high enough to bombard all the monomer into pieces, some monomer will still keep its monomer characteristic. During the depositing process, those monomer, which is not bombarded into pieces, will cross-link with other monomer to form the particle stacking. Fortunately, the mentioned particle stacking will not affect the deposition result.

The plasma depositing pristine membrane is individually passed through carbonizing process at 300° C., 500° C., and 700° C., and presented as cp300, cp500, and cp700. Referred to FIGS. 5C, 5E and 5G, after the carbonizing process, the surfaces of the cp300, cp500, and cp700 are not affected. From FIGS. 5D, 5F and 5H, it can be found that when the carbonizing temperature is raised, the thickness will be decreased from 1 μm of the pristine membrane to 0.12 μm of cp700.

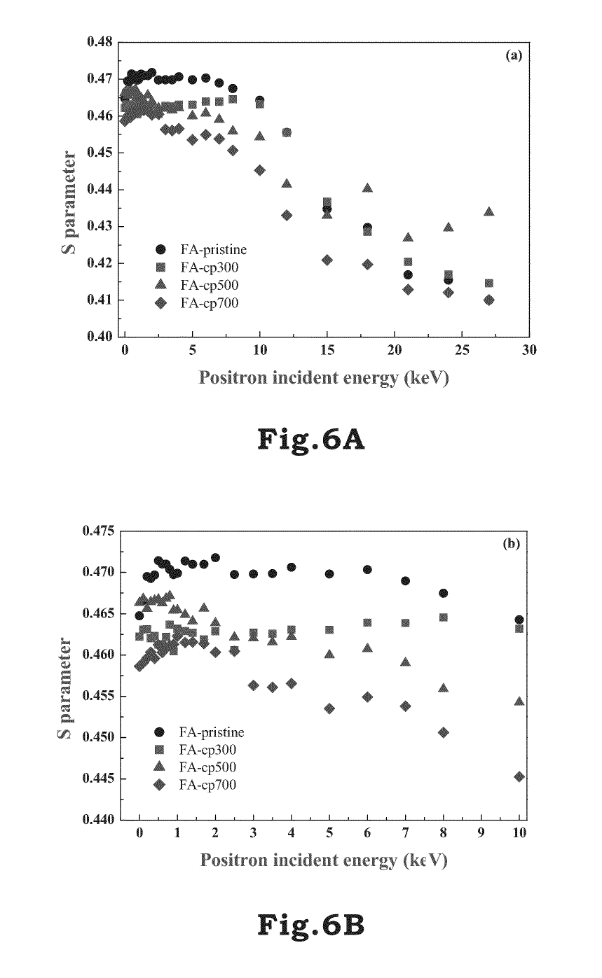

The tendency of the thickness decreased also can be found in the spectrum of variable mono-energy slow positron beam (VMSPB) with depth profile measured by Doppler broadening energy spectroscopy, as shown in FIG. 6. The turning point of the pristine membrane selective layer and the substrate interface layer is about 10 keV, and the turning point of Fa-cp500 and FA-cp 700 is down to about 2 keV. Co-ordinating the above-mentioned result with SEM spectrum, it can approve that when the carbonizing temperature is raised, the thickness of the selective layer will be decreased.

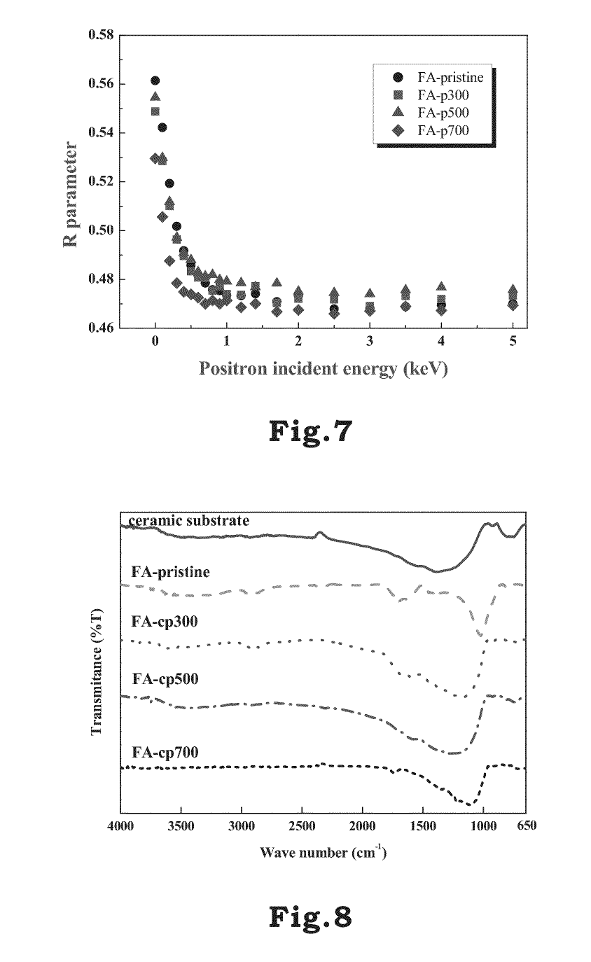

Besides, from the surface image as shown in FIGS. 5C, 5E, and 5G, we can find that there is no defect occurred during the carbonizing process. The mentioned result can also be approved by that the R parameter decreases sharply then is kept constant with increasing positron incident energy as shown in FIG. 7. It indicate that there are no defects formed in the selective layer, the defects free carbon molecular sieve membrane can be produced from the pristine membrane, from plasma depositing process, by one time depositing/carbonizing process.

The difference between the FA-pristine membrane before and after the carbonizing process can be observed by the ATR-FTIR spectrum in FIG. 8. Referred to FIG. 8, it can be found that the characteristic absorption peaks of the FA-pristine membrane as the characteristic absorption peak of —CH₂— at 2925 cm⁻¹, the characteristic absorption peak of ═C—O—C═ of fufan ring at 1025 and 1080 cm⁻¹, and the characteristic absorption peak of —C═C— of fufan ring at 1570 and 1510 cm⁻¹. With the increasing of the carbonizing temperature, it seems that those mentioned characteristic absorption peaks are decreased. But the major characteristic absorption peaks are still similar to the substrate. It can be supposed that the thickness of the selective layer of the carbon molecular sieve membrane are decreased after the carbonizing process, and the substrate can absorb most infrared radiation. Therefore, the observed IR spectrum is more close to the absorption peaks of the substrate.

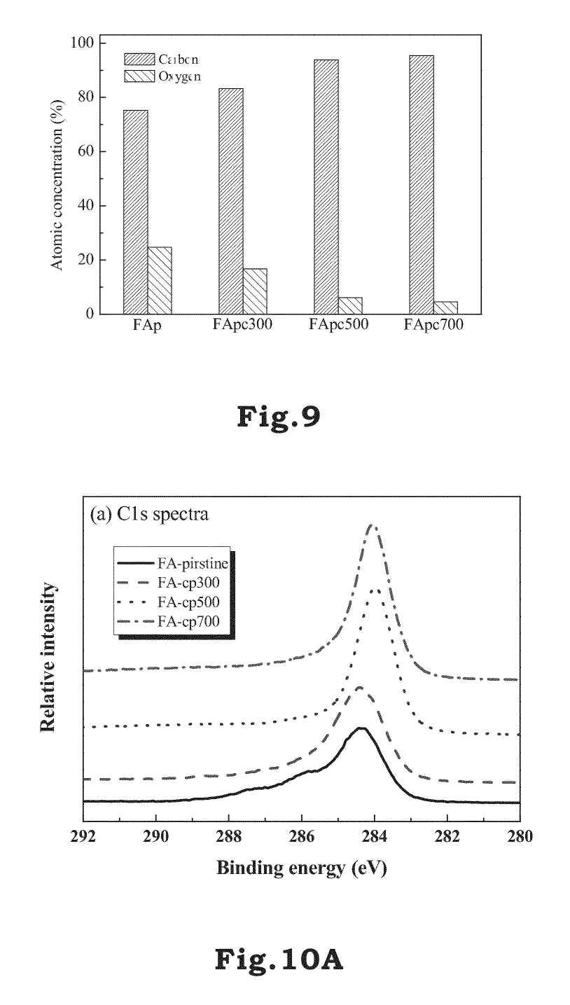

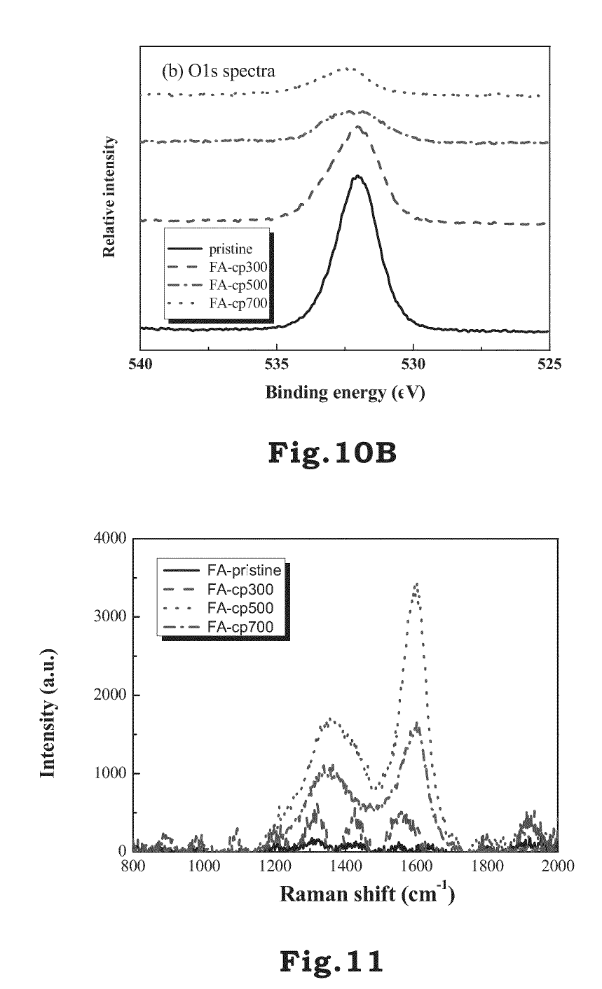

Moreover, we also use X-ray Photoelectron Spectroscopy (XPS) for indentifying the surface element, and the result is shown as FIG. 9. Since the range of the XPS characterization of the membrane surface is within 10 nm, it is expected that the effect of the ceramic substrate is outside of such range Referred to FIG. 9, the carbon element content of the FA pristine membrane is 75.3%, which is slightly higher than the carbon element content of FA (71.4%). It means that there may be some cross-linking structure formed during the plasma depositing process. After the carbonizing process, the carbon element content is raised, and the whole membrane becomes carbon-rich structure. The mentioned result can be observed more clearly in the Cls spectrum in FIG. 10A and in the Cls spectrum in FIG. 10B. It can be observed in the mentioned oxygen (Ols) spectrums that the FA-pristine membrane is presented as a broad peak. That is, during the plasma depositing process, some oxygen contained functional group in the FA monomer may be broken, and some random structures, as O═C/O—C═O (532.2 eV) and C—O—H/C—O—C (532.8 eV), are formed therefrom. From the Cls spectrums, it is obviously observed that peaks at C—H/C—C (285 eV), C—O—H/C—O—C (286.5 eV), and C═O/C—O—C (288.0 eV). When the carbonizing temperature is raised to 300° C., the peaks of C—O—H/C—O—C and C═O/C—O—C are slightly decreased. That means when raising the carbonizing temperature to 300° C., the oxygen contained functional groups in the FA monomer are gradually broken, and the carbon element content in the spectrum is increased from 75.3% to 83.2%. When raising the carbonizing temperature to 500° C. due to a lot of oxygen contained functional groups were broken, the carbon element content is increased to more than 93.9, and the oxygen element content is decreased thereby. The peaks of C—O—H/C—O—C and C═O/C—O—C are almost disappeared. When raising the carbonizing temperature to 700° C., the left oxygen element content is only 4.6%.

From the Raman spectrums as shown in FIG. 11, it can be found that there is no absorption peak at 1600 cm⁻¹ (G band) and 1360 cm⁻¹ (D band) in the spectra of the FA pristine and the FA-cp300 membrane. Integrating the mentioned XPS results and the mentioned Raman spectra, it can be found that there is no graphitization or in-organization occurred to both of the FA pristine and the FA-cp300 membrane.

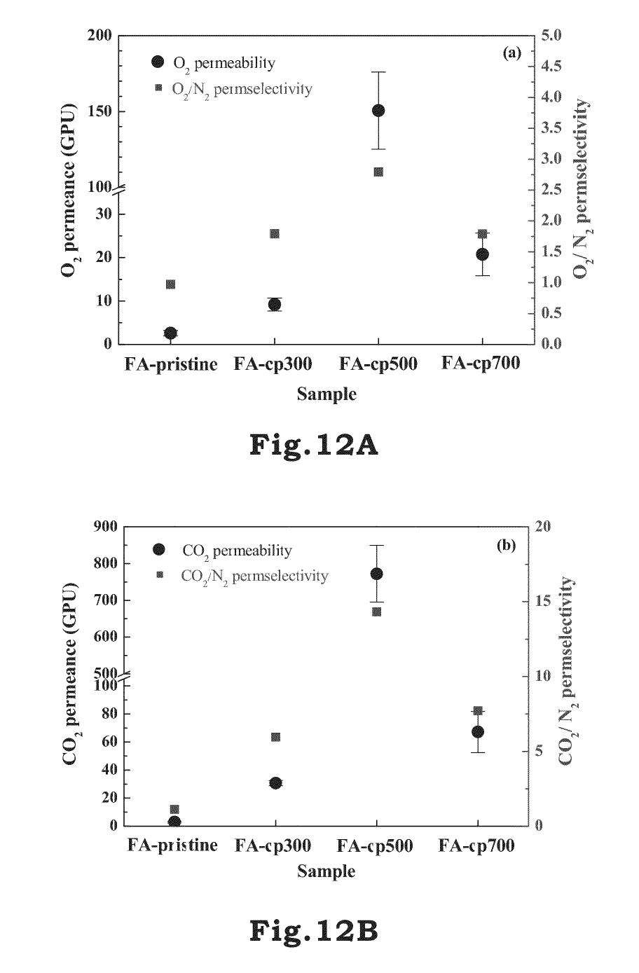

The mentioned results can be connected with FIG. 12, wherein the measured low gas separation, permeability, and selectivity are not increased. On the other hand, the samples of both FA-cp500 and FA-cp700 are inorganized and presented in graphite-like structure. Because the broken material is released and the chemical structure becomes graphite-like, there is opportunity to form penetrating micropores in those samples, so that the permeance of those samples is obviously raised. Additionally, as shown in FIG. 12, because the S parameter of FA-cp500 is the highest one in those membranes with high carbonized degree, so that the permeance of FA-cp500 is the highest one in those membranes with high carbonized degree. The carbon dioxide permeance of FA-cp500 is 772.1 GPU, and the oxygen permeance of FA-cp500 is 772.1 GPU. The CO₂/N₂ selectivity of FA-cp500 is 14.3, and the O₂/N₂ selectivity of FA-cp500 is 2.8. When rising the carbonizing temperature to 700° C., the penetrating micropores is going to be decreased, and the S parameter is reduced, as shown in FIG. 12. Therefore, when gas passing through the membranes, because the resistance in the membranes is increased, the gas permeance and the selectivity will be both decreased.

TABLE 2

| | | Substrate | | Permeance (GPU) | | Selectivity | |
|---|---|---|---|---|---|---|---|
| Membrane | | pore size | | CO₂ | O₂ | CO₂/N₂ | O₂/N₂ |
| FA-cp300 | plate | 10 | nm | 30 | 8 | 6.25 | 1.75 |
| FA-cp500 | plate | 10 | nm | 772.1 | 150.6 | 14.32 | 2.79 |
| FA-cp700 | plate | 10 | nm | 70 | 20 | 7.5 | 1.8 |
| PFA-600 | tubular | 110 | nm | 1.9 | 0.6 | 24.80 | 8.60 |
| VDP600 | tubular | 5 | nm | 17.5 | 2.3 | 79.29 | 10.56 |
| cPFA500 | plate | 200 | nm | 2.4 | — | ~3.20 | — |

In Table 2, FA-cp300, FA-cp500, FA-cp700 individually represent those carbon molecular sieve membranes consisted of FA monomer obtained from one time plasma depositing/carbonizing process of this invention, and the carbonizing temperature of FA-cp300, FA-cp500, FA-cp700 is respectively 300° C., 500° C., 700° C. The data of the membrane PFA-600 is extracted from the literature of Chengwen Song, Tonghua Wang, Xiuyue Wang, Jieshan Qiu, Yiming Cao, Preparation and gas separation properties of poly(furfuryl alcohol)-based C/CMS composite membranes, Separation and Purification Technology 58 (2008) 412-418. The data of the membrane VDP-600 is extracted from the literature of Huanting Wang, Lixiong Zhang, George R. Gavalas, Preparation of supported carbon membranes from furfuryl alcohol by vapor deposition polymerization, Journal of Membrane Science 177 (2000) 25-31. The data of the membrane cPFA500 is extracted from the literature of Clare J. Anderson, Steven J. Pas, Gaurav Arora, Sandra E. Kentish, Anita J. Hill, Stanley I. Sandler, GeoffW. Stevens, Effect of pyrolysis temperature and operating temperature on the performance of nanoporous carbon membranes, Journal of Membrane Science 322 (2008) 19-27.

Comparing the gas separation performance the carbon molecular sieve membrane consisted of FA monomer obtained from the method of this invention and the data of the carbon molecular sieve membrane made of PFA in literature, we find that the gas separation performances of the carbon molecular sieve membranes of this invention are better than that of the carbon molecular sieve membranes in literature, as shown in the above Table 2. The possible reasons are as the following. (1) During the manufacturing process in the prior art, the PFA solution is easily permeated into the pores of the substrate, and the resistance of the produced membrane will be increased. (2) Because the defects free carbon molecular sieve membrane of this invention is fabricated by one time plasma depositing/carbonizing process, not by multiple times coating/carbonizing process in the prior art, the resistance of the carbon molecular sieve membrane of this invention is lower than that of the composite membrane in the prior art. (3) In the fabricating method of this invention, during the plasma depositing process, the monomer will be cross-linked directly after the coating process. If necessary, more than one times of coating and cross-linking procedure can be performed. And the carbonizing process is finally performed. Oppositely, in the prior art, the manufacturing process is to repeat the PFA coating/carbonizing process for several times, and it can not be ensured that whether the carbonized composite membrane formed in the last procedure is better in the performance.

According to the above examples, it can be found that the fabricating method combining plasma depositing process with carbonizing process of this invention can provide defects free carbon molecular sieve membrane through one time depositing/carbonizing process. Therefore, comparing with the method in the prior art employing multiple times coating/carbonizing process to reduce defects, this invention provides a method for fabricating carbon molecular sieve membrane with more industrial competitive ability.

Because oxygen contained material will be released to form pores during the carbonizing process, the mentioned examples use FA as the monomer for plasma depositing onto a porous ceramic substrate to produce plasma deposited pristine membrane. And then, through carbonizing process, the chemical characteristics of the mentioned pristine membrane will be changed and the thickness of the membrane will be decreased, so that the gas separation performance will be increased.

From the SEM images and the spectra of variable monoenergy slow positron beam (VMSPB) measured by Doppler broadening energy spectroscopy in the above examples, it can be found that when the carbonizing temperature is higher, the thickness of the produced membrane will be decreased. The membrane surface is still defects free, and the gas resistance of the membrane can be decreased, so that the permeance can be improved.

From the XPS spectra and the Raman spectra in the above examples, it can be found that when the carbonizing temperature is higher than 500° C., the structure of the membrane is going to be inorganized and form graphite structure. The defects shown as the D band is also possible to increase the gas permeance. When the carbonizing temperature is 700° C., the thickness of the membrane is the thinnest one among those samples. But, from the S parameter of the selective layer, it can be seen that the pore size of membranes decreased, resulting in the gas permeance and the selectivity of the membrane are decreased at the same time.

The carbon molecular sieve membrane without defects obtained from one time of the process combining plasma depositing and carbonizing in the examples can provide excellent gas permeability and selectivity. The carbon dioxide permeance of the carbon molecular sieve membrane is 772.1 GPU, and the oxygen permeance of the carbon molecular sieve membrane is 150.6. The selectivity of carbon dioxide/nitrogen of the carbon molecular sieve membrane is 14.3, and the selectivity of oxygen/nitrogen of the carbon molecular sieve membrane is 2.8.

In summary, this invention has reported a method for fabricating carbon molecular sieve membrane. The method for fabricating carbon molecular sieve membrane comprises performing chemical vapor deposition (CVD) with reacting monomer to form a pristine membrane on a substrate, and then performing carbonizing. According to this invention, the mentioned chemical vapor deposition can be plasma enhanced chemical vapor deposition. As the disclosure of this specification, through combining the technology of chemical vapor deposition and carbonization, one time depositing/carbonizing process can produce a carbon molecular sieve membrane without defects and the thickness of the carbon molecular sieve membrane is ultra-thin. During the CVD process, the monomer is uniformly coated on the surface of the substrate and forming a pristine membrane. And, the surface of the mentioned pristine membrane does not have defects. Through the carbonizing process, the chemical characteristics of the pristine membrane will be changed, and the thickness of the pristine membrane will be decreased, so that the gas separating performance of the mentioned carbon molecular sieve membrane will be improved. The mentioned method for fabricating carbon molecular sieve membrane can provide the carbon molecular sieve membrane without defects through one time depositing/carbonizing process, and the carbon molecular sieve membrane can provide excellent gas permeability and separating performance. Comparing with the manufacturing method in the prior art to reduce the defects by operating multiple times of coating/carbonizing process, this invention provide a method to produce defects free carbon molecular sieve membrane, and the mentioned method can save more time and energy in the manufacturing process for forming the carbon molecular sieve membrane. Preferably, the carbon molecular sieve membrane of this invention is with the advantages of thin thickness, high gas permeance, and high gas selectivity. More preferably, in one preferred example of this invention, we also can perform multiple times of CVD to form pristine membranes on the substrate, and then perform a carbonizing process to form the carbon molecular sieve membrane, so that a membrane with more improved separating performance can be produced therefrom. More preferably, in another preferred example of this invention, the same or different monomer(s) can be employed in the multiple times CVD to form pristine membranes on the substrate, and then perform a carbonizing process to form the carbon molecular sieve membrane, so that a membrane with more improved characteristics can be obtained, wherein the mentioned carbon molecular sieve membrane, with the used monomer(s), can provide better separating performance, or can be applied in more kinds of gas separation. Therefore, this invention discloses a more simply operating, more economic manufacturing, more fast membrane forming, and more environmental friendly method for fabricating carbon molecular sieve membrane.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for fabricating carbon molecular sieve membrane, comprising:
performing chemical vapor deposition (CVD) process to coat a reacting monomer onto surface of a substrate to form a pristine membrane on the surface of the substrate; and
treating said pristine membrane with carbonizing process to form a carbon molecular sieve membrane.

2. The method for fabricating carbon molecular sieve membrane according to claim 1, wherein said reacting monomer is furfuryl alcohol (FA).

3. The method for fabricating carbon molecular sieve membrane according to claim 1, wherein said chemical vapor deposition is Plasma-enhanced chemical vapor deposition (PECVD).

4. The method for fabricating carbon molecular sieve membrane according to claim 1, wherein the temperature of said carbonizing process is 450-900° C.

5. The method for fabricating carbon molecular sieve membrane according to claim 1, wherein the temperature of said carbonizing process is 500-700° C.

6. The method for fabricating carbon molecular sieve membrane according to claim 1, wherein the thickness of the carbon molecular sieve membrane is 0.1-1.0 μm.

7. The method for fabricating carbon molecular sieve membrane according to claim 1, wherein the thickness of the carbon molecular sieve membrane is 0.2-0.6 μm.

8. The method for fabricating carbon molecular sieve membrane according to claim 1, wherein the CO₂/N₂ selectivity of the carbon molecular sieve membrane is 2.0-20.

9. The method for fabricating carbon molecular sieve membrane according to claim 1, wherein the O₂/N₂ selectivity of the carbon molecular sieve membrane is 5.0-15.

10. The method for fabricating carbon molecular sieve membrane according to claim 3, wherein the power of said plasma-enhanced chemical vapor deposition process is 10-100 W.

11. The method for fabricating carbon molecular sieve membrane according to claim 1, wherein the substrate is selected from one of the following: ceramic, carbon.

12. A method for fabricating carbon molecular sieve membrane, comprising:
performing plasma-enhanced chemical vapor deposition (PECVD) process to coat a reacting monomer onto surface of a substrate to form a pristine membrane on the surface of the substrate; and
treating said pristine membrane with carbonizing process to form a carbon molecular sieve membrane.

13. The method for fabricating carbon molecular sieve membrane according to claim 12, wherein said reacting monomer is furfuryl alcohol (FA).

14. The method for fabricating carbon molecular sieve membrane according to claim 12, wherein the temperature of said carbonizing process is 450-900° C.

15. The method for fabricating carbon molecular sieve membrane according to claim 12, wherein the temperature of said carbonizing process is 500-700° C.

16. The method for fabricating carbon molecular sieve membrane according to claim 12, wherein the thickness of the carbon molecular sieve membrane is 0.1-1.0 μm.

17. The method for fabricating carbon molecular sieve membrane according to claim 12, wherein the thickness of the carbon molecular sieve membrane is 0.2-0.6 μm.

18. The method for fabricating carbon molecular sieve membrane according to claim 12, wherein the CO₂/N₂ selectivity of the carbon molecular sieve membrane is 2.0-20.

19. The method for fabricating carbon molecular sieve membrane according to claim 12, wherein the O₂/N₂ selectivity of the carbon molecular sieve membrane is 5.0-15.

20. The method for fabricating carbon molecular sieve membrane according to claim 12, wherein the substrate is selected from one of the following: ceramic, carbon, metal.

21. The method for fabricating carbon molecular sieve membrane according to claim 12, wherein the substrate is performed at least one time of said plasma-enhanced chemical vapor deposition process, before performing said carbonizing process, to form a plurality of said pristine membrane.
